(19) United States
(12) Patent Application Publication
(10) Pub. No.: US 2013/0268268 A1
(43) Pub. Date: Oct. 10, 2013

(54) ENCODING OF AN IMPROVEMENT STAGE IN A HIERARCHICAL ENCODER

(71) Applicants: Balazs Kovesi, Lannion (FR); Stéphane Ragot, Lannion (FR); Alain Le Guyader, Lannion (FR)

(72) Inventors: Balazs Kovesi, Lannion (FR); Stéphane Ragot, Lannion (FR); Alain Le Guyader, Lannion (FR)

(73) Assignee: FRANCE TELECOM, Paris (FR)

(21) Appl. No.: 13/995,014

(22) PCT Filed: Dec. 13, 2011
(86) PCT No.: PCT/FR11/52959

§ 371 Date: Jun. 17, 2013

(30) Foreign Application Priority Data
Dec. 16, 2010 (FR) 1060631

(51) Int. Cl. G10L 19/00

(52) U.S. Cl. CPC G10L 19/00
USPC 704/230

(57) ABSTRACT

A method and coding device are provided for coding a digital audio input signal in a hierarchical coder, which includes a core coding stage with B bits and at least one current improvement coding stage k, delivering quantization indices which are concatenated to form the indices of a preceding embedded coder. The method includes: obtaining possible quantization values for the current improvement stage k by determining absolute reconstruction levels of just the current stage k on the basis of the indices of the preceding embedded coder; and quantizing the input signal of the hierarchical coder having undergone or not a perceptual weighting processing, on the basis of the possible quantization values so as to form a scalar quantization index for the stage k and a quantized signal corresponding to one of the possible quantization values.

### CROSS-REFERENCE TO RELATED APPLICATIONS

This application is a Section 371 National Stage application of International Application No. PCT/FR2011/052959, filed Dec. 13, 2011, which is incorporated by reference in its entirety and published as WO 2012/080649 on Jun. 21, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present invention relates to the field of the coding of digital signals.

The coding according to the invention is adapted especially for the transmission and/or the storage of digital signals such as audiofrequency signals (speech, music or the like).

The present invention pertains more particularly to waveform coding such as PCM (“Pulse Code Modulation”) coding, or to adaptive waveform coding of ADPCM (“Adaptive Differential Pulse Code Modulation”) coding type. The invention pertains especially to embedded-code coding making it possible to deliver scalable binary train quantization indices.

### BACKGROUND OF THE DISCLOSURE

The general principle of the embedded-code ADPCM coding/decoding specified by ITU-T recommendation G.722 or ITU-T G.727 is such as described with reference to FIGS. 1 and 2.

FIG. 1 thus represents an embedded-code coder of ADPCM type (e.g.: G.722 low band, G.727) operating between B and B+K bits per sample; note that the case of a non-scalable ADPCM coding (e.g.: G.726, G.722 high band) corresponds to K=0, where B is a fixed value which can be chosen from among various possible bitrates.

It comprises:
a prediction module 110 making it possible to give the prediction of the signal x_{P}^{B}(n) on the basis of the previous samples of the quantized error signal e_{Q}^{B}(n′)=y_{I}_{^{B}}^{B}(n′)v(n′) n′=n−1, . . . , n−N_{Z}, where v(n′) is the quantization scale factor, and of the reconstructed signal r^{B}(n′) n′=n−1, . . . , n−Nₚ where n is the current instant.
a subtraction module 120 which deducts from the input signal x(n) its prediction x_{P}^{B}(n) to obtain a prediction error signal denoted e(n).
a quantization module 130 Q^{B+K} for the error signal which receives as input the error signal e(n) to give quantization indices I^{B+K}(n) consisting of B+K bits. The quantization module Q^{B+K} is of embedded-code type, that is to say it comprises a “core” quantizer with B bits and quantizers with B+k k=1, . . . , K bits which are embedded on the “core” quantizer.

In the case of the coding of the low band of the ITU-T G.722 standard, the decision levels and the reconstruction levels of the quantizers Q^{B}, Q^{B+1}, Q^{B+2} for B=4 and K=0.1 or 2 are defined by tables IV and VI of the overview article describing the G.722 standard by X. Maitre “7 kHz audio coding within 64 kbit/s.” IEEE Journal on Selected Areas in Communication, Vol. 6, No. 2, February 1988.

The quantization index I^{B+K}(n) of B+K bits at the output of the quantization module Q^{B+K} is transmitted via the transmission channel 140 to the decoder such as described with reference to FIG. 2.

The coder also comprises:
a module 150 for deleting the K low-order bits of the index I^{B+K}(n) to give a low bitrate index I^{B}(n) on B bits;
an inverse quantization module 121 (Q^{B})⁻¹ to give at the output a quantized error signal e_{Q}^{B}(n)=y_{I}_{^{B}}^{B}(n)v(n) on B bits;
a module 170 Q_{Adapt} for adapting the quantizers and inverse quantizers to give a level control parameter v(n) also called a scale factor, for the following instant;
a module 180 for adding the prediction x_{P}^{B}(n) to the quantized error signal to give the low-bitrate reconstructed signal r^{B}(n);
a module 190 P_{Adapt} for adapting the prediction module on the basis of the quantized error signal on B bits e_{Q}^{B}(n) and of the signal e_{Q}^{B}(n) filtered by 1+P_{z}(z).

It may be noted that in FIG. 1 the dashed part referenced 155 represents the low-bitrate local decoder which contains the predictors 165 and 175 and the inverse quantizer 121. This local decoder thus makes it possible to adapt the inverse quantizer at 170 on the basis of the low bitrate index I^{B}(n) and to adapt the predictors 165 and 175 on the basis of the reconstructed low bitrate data.

This part is found identically in the embedded-code ADPCM decoder such as described with reference to FIG. 2.

The embedded-code ADPCM decoder of FIG. 2 receives as input the indices I^{B+K} arising from the transmission channel 140, a version of I^{B+K} possibly disturbed by binary errors, and carries out an inverse quantization by the inverse quantization module 210 (Q^{B})⁻¹ of bitrate B bits per sample to obtain the signal e′_{Q}^{B}(n)=y′_{I′}_{^{B}}^{B}(n)v′(n). The symbol “′” indicates a value decoded on the basis of the bits received, which is possibly different from that used by the coder on account of transmission errors.

The output signal r′^{B}(n) for B bits will be equal to the sum of the prediction of the signal and of the output of the inverse quantizer with B bits. This part 255 of the decoder is identical to the low bitrate local decoder 155 of FIG. 1.

Employing the mode bitrate indicator and the selector 220, the decoder can improve the restored signal.

Indeed if mode indicates that B+1 bits have been received, the output will be equal to the sum of the prediction x_{P}^{B}(n) and of the output of the inverse quantizer 230 with B+1 bits y′_{I}_{^{B+1}}^{B+1}(n)v′(n).

If mode indicates that B+2 bits have been received then the output will be equal to the sum of the prediction x_{P}^{B}(n) and of the output of the inverse quantizer 240 with B+2 bits y′_{I}_{^{B+2}}^{B+2}(n)v′(n).

By using z-transform notation, we may write that in this looped structure:

R^{B+k}(z)=X(Z)+Q^{B+k}(z)

defining the quantization noise with B+k bits Q^{B+k}(z) by:

Q^{B+k}(z)=E_{Q}^{B+k}(z)−E(z)

The embedded-code ADPCM coding of the ITU-T standard G.722 (hereinafter named G.722) carries out a coding of the signals in wideband which are defined with a minimum bandwidth of [50-7000 Hz] and sampled at 16 kHz. The G.722 coding is an ADPCM coding of each of the two signal sub-bands [0-4000 Hz] and [4000-8000 Hz] obtained by decomposition of the signal by quadrature minor filters. The low band is coded by an embedded-code ADPCM coding on 6, 5 and 4 bits while the high band is coded by an ADPCM coder of 2 bits per sample. The total bitrate will be 64, 56 or 48 bit/s according to the number of bits used for the decoding of the low band.

This coding was firstly developed for use in the ISDN (Integrated Services Digital Network). It has recently been deployed in the applications of improved quality telephony termed “High Definition (HD) voice” over IP network.

For a quantizer with a large number of levels, the spectrum of the quantization noise will be relatively flat. However, in the frequency zones where the signal has low energy, the noise may have a comparable or indeed greater level than the signal and is therefore no longer necessarily masked. It may then become audible in these regions.

A shaping of the coding noise is therefore necessary. In a coder such as G.722, a coding noise shaping adapted to an embedded-code coding is moreover desirable.

Generally, the aim of shaping the coding noise is to obtain quantization noise whose spectral envelope follows the short-term masking threshold; this principle is often simplified so that the spectrum of the noise approximately follows the spectrum of the signal, ensuring a more homogeneous signal-to-noise ratio so that the noise remains inaudible even in the zones of lower energy of the signal.

A noise shaping technique for a coding of embedded-code PCM (“Pulse Code Modulation”) type is described in ITU-T recommendation G.711.1 “Wideband embedded extension for G.711 pulse code modulation” or “G.711.1: A wideband extension to ITU-T G.711”. Y. Hiwasaki, S. Sasaki, H. Ohmuro, T. Mori, J. Seong, M. S. Lee, B. Kövesi, S. Ragot, J.-L. Garcia, C. Marro, L. M., J. Xu, V. Malenovsky, J. Lapierre, R. Lefebvre. EUSIPCO, Lausanne, 2008.

This recommendation thus describes a coding with shaping of the coding noise for a core bitrate coding. A perceptual filter for shaping the coding noise is computed on the basis of the past decoded signals, arising from an inverse core quantizer. A core bitrate local decoder therefore makes it possible to compute the noise shaping filter. Thus, at the decoder, it is possible to compute this noise shaping filter on the basis of the core bitrate decoded signals.

A quantizer delivering improvement bits is used at the coder.

The decoder receiving the core binary stream and the improvement bits, computes the filter for shaping the coding noise in the same manner as at the coder on the basis of the core bitrate decoded signal and applies this filter to the output signal of the improvement bits inverse quantizer, the shaped high bitrate signal being obtained by adding the filtered signal to the decoded core signal.

The shaping of the noise thus improves the perceptual quality of the core bitrate signal. It offers limited improvement in quality for the improvement bits. Indeed, the shaping of the coding noise is not performed for the coding of the improvement bits, the input of the quantizer being the same for the core quantization as for the improved quantization.

The decoder must then delete a resulting spurious component by a suitable filtering, when the improvement bits are decoded in addition to the core bits.

The additional computation of a filter at the decoder increases the complexity of the decoder.

This technique is not used in the already existing standard scalable decoders of G.722 or G.727 decoder type. There therefore exists a need for improving the quality of the signals whatever the bitrate while remaining compatible with the existing standard scalable decoders.

A solution not making it necessary to perform complementary signal processing at the decoder is described in patent application WO 2010/058117. In this application, the signal received at the decoder can be decoded by a standard decoder able to decode the core bitrate and embedded-bitrates signal without requiring any computation for shaping the noise or corrective term.

This document describes that for a hierarchical coder improvement stage, the quantization is performed by minimizing a quadratic error criterion in a perceptually filtered domain.

Accordingly, a coding noise shaping filter is defined and applied to an error signal determined on the basis at least of a reconstructed signal of a preceding coding stage. The scheme also requires the computation of the reconstructed signal of the current improvement stage as forecast of a following coding stage.

Moreover, improvement terms are computed and stored for the current improvement stage. This therefore introduces significant complexity and significant storage of improvement terms or reconstructed signal samples of the previous stages.

This solution is therefore not optimal from a complexity point of view.

There therefore exists a need to improve the prior art schemes for coding and shaping the improvement coding noise, while remaining compatible with existing hierarchical decoders.

### SUMMARY

The present invention is apt to improve the situation.

It proposes for this purpose, a method for coding a digital audio input signal (x(n)) in a hierarchical coder comprising a core coding stage with B bits and at least one current improvement coding stage k, the core coding and the coding of the improvement stages preceding the current stage k delivering quantization indices which are concatenated to form the indices of the preceding embedded coder (I^{B+k-1}). The method is such that it comprises the following steps:
obtaining of possible quantization values for the current improvement stage k on the basis of the absolute reconstruction levels of just the current stage k and of the indices of the preceding embedded coder;
quantization of the input signal of the hierarchical coder having undergone or not a perceptual weighting processing, on the basis of said possible quantization values so as to form a quantization index for stage k and a quantized signal corresponding to one of the possible quantization values.

Thus, the quantization of the improvement stage determines the quantization index bit or bits which are directly concatenated with the indices of the previous stages. In contradistinction to the prior art schemes, there is no computation of an improvement signal or improvement terms.

Moreover, the signal at the input of the quantization is either directly the hierarchical coder input signal, or this same input signal having directly undergone a perceptual weighting processing. Here this does not involve a difference signal for the difference between the input signal and a reconstructed signal of the coding stages preceding, as in the prior art techniques.

The complexity in terms of computational load is thereby reduced.

Moreover, in contradistinction to the prior art schemes, the stored quantization values are not differential values. Thus, it is not useful to store the quantization values serving as reconstruction in the previous stages so as to construct a quantization dictionary for the improvement stage.

Moreover, in contradistinction to the prior art schemes, it is not necessary to construct and to store a differential dictionary, since the improvement stage uses directly absolute levels stored by the existing hierarchical encoder and decoder (yᵢ^{B+K}(n)). Thus the invention avoids the duplication of the dictionaries that may be encountered in the prior art schemes where a differential dictionary is used at the coder and an absolute dictionary at the decoder.

The memory required for the storage of the dictionaries and the operations of quantization at the coder and inverse quantization at the decoder is therefore reduced.

Finally, obtaining the quantization values of the improvement stage directly, without performing a difference, introduces additional accuracy between the values obtained at the coder and those obtained at the decoder when working for example in finite accuracy.

The various particular embodiments mentioned hereinafter may be added independently or in combination with one another, to the steps of the method defined hereinabove.

In a particular embodiment, the input signal has undergone a perceptual weighting processing using a predetermined weighting filter to give a modified input signal, before the quantization step and the method furthermore comprises a step of adapting the memories of the weighting filter on the basis of the quantized signal of the current improvement coding stage.

This perceptual weighting processing applied directly to the input signal of the hierarchical coder for the improvement coding of stage k also reduces the complexity in terms of computational load with respect to the prior art techniques which performed this perceptual weighting processing on a difference signal for the difference between the input signal and a reconstructed signal of the preceding coding stages.

Thus, the coding method described also allows the existing decoders to decode the signal without there being any modifications to be made or additional processing to be envisaged while benefiting from the improvement of the signal by effective coding noise shaping.

In a particular embodiment, the possible quantization values for improvement stage k furthermore contain a scale factor and a prediction value originating from the core coding of adaptive type.

This makes it possible to adapt the quantization values with respect to the values defined in the core coding.

In an alternative embodiment, the modified input signal to be quantized at improvement stage k is the perceptually weighted input signal from which is subtracted a prediction value originating from the core coding of adaptive type.

This also makes it possible to adapt the quantization values with respect to the values defined in the core coding but by performing this adaptation at the input of the quantizer rather than on each quantization value. This is advantageous in the case where the improvement is performed on several bits.

In a particular manner, the perceptual weighting processing is performed by prediction filters forming a filter of ARMA type.

The shaping of the improvement coding noise is then of good quality.

The present invention also pertains to a hierarchical coder of a digital audio input signal, comprising a core coding stage with B bits and at least one current improvement coding stage k, the core coding and the coding of the improvement stages preceding the current stage k delivering quantization indices which are concatenated to form the indices of the preceding embedded coder. The coder is such that it comprises:
a module for obtaining possible quantization values for the current improvement stage k by determining absolute reconstruction levels of just the current stage k on the basis of the indices of the preceding embedded coder;
a module for quantizing the input signal of the hierarchical coder having undergone or not a perceptual weighting processing, on the basis of said possible quantization values so as to form a quantization index for stage k and a quantized signal corresponding to one of the possible quantization values.

The hierarchical coder furthermore comprises a preprocessing for perceptual weighting module using a predetermined weighting filter to give a modified input signal at the input of the quantization module and a module for adapting the memories of the weighting filter on the basis of the quantized signal of the current improvement coding stage.

The hierarchical coder affords the same advantages as those of the method that it implements.

The invention also pertains to a computer program comprising code instructions for the implementation of the steps of the coding method according to the invention, when these instructions are executed by a processor.

The invention pertains finally to a storage means readable by a processor storing a computer program such as described.

### BRIEF DESCRIPTION OF THE DRAWINGS

Other characteristics and advantages of the invention will be more clearly apparent on reading the following description, given solely by way of nonlimiting example and with reference to the appended drawings in which:

FIG. 1 illustrates an embedded-code coder of ADPCM type according to the state of the art and such as described above;

FIG. 2 illustrates an embedded-code decoder of ADPCM type according to the state of the art and such as described above;

FIG. 3 illustrates a general embodiment of the coding method according to the invention and of a coder according to the invention;

FIG. 4 illustrates a first particular embodiment of the coding method and of a coder according to the invention;

FIG. 5 illustrates a second particular embodiment of the coding method and of a coder according to the invention;

FIG. 6 illustrates a third particular embodiment of the coding method and of a coder according to the invention;

FIG. 7 illustrates a general alternative embodiment of the coding method and of a coder according to the invention;

FIG. 7b illustrates another general alternative embodiment of the coding method and of a coder according to the invention;

FIG. 8 illustrates an exemplary embodiment of the core coding of a coder according to the invention;

FIG. 9 illustrates an example of quantization reconstruction levels used in the state of the art; and

FIG. 10 illustrates a hardware embodiment of a coder according to the invention.

### DETAILED DESCRIPTION OF ILLUSTRATIVE EMBODIMENTS

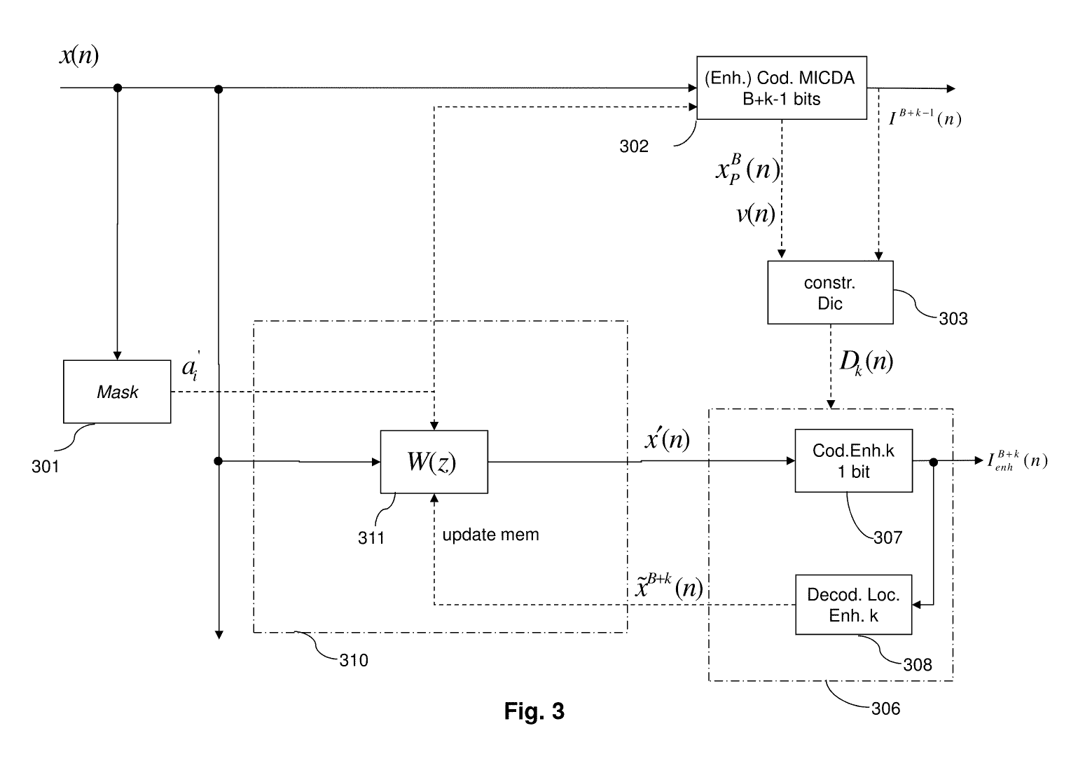

With reference to FIG. 3, a coder as well as a coding method according to one embodiment of the invention is described.

It is recalled that considered here is the case of an embedded-code coder or hierarchical coder in which a core coding with B bits and at least one improvement stage of rank k is envisaged. The core coding and the improvement stages preceding the coding of improvement stage k such as represented at 306 deliver scalar quantization indices multiplexed in the index I^{B+k-1}(n) of B+k−1 bits per sample.

In the exemplary embodiments described hereinafter, for the sake of simplifying the presentation, the improvement stage (of rank k) is presented as producing an additional bit per sample. In this case, the coding in each improvement stage involves selecting one out of two possible values. As will subsequently be apparent, the “absolute dictionary”—in terms of absolute levels (in the sense of “non-differential”)—corresponding to all the quantization values that the improvement stage of rank k can produce, is of size 2^{B+k}, or sometimes slightly less than 2^{B+k} as for example in the G.722 coder which has only 60 possible levels instead of 64 in the low-band 6-bit quantizer. The hierarchical coding involves a binary tree structure of the “absolute dictionary”, which explains that one improvement bit suffices to perform the coding, given the B+k−1 bits of the previous stages.

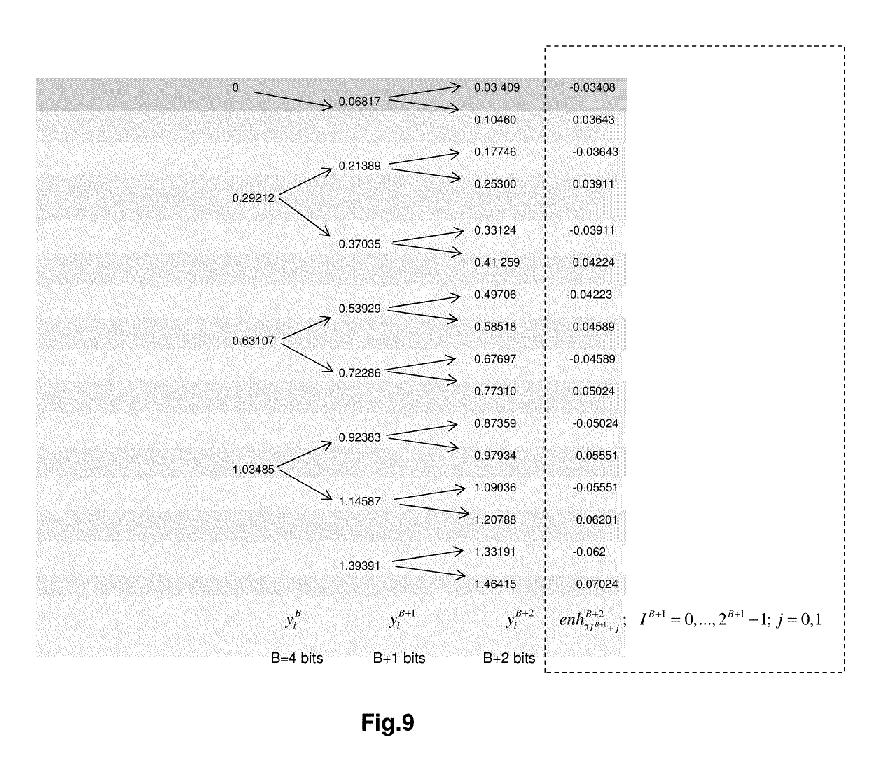

FIG. 9 is an extract from table VI of the aforementioned X. Maitre article and represents the first 4 levels of the core quantizer with B bits for B=4 bits and the levels of the quantizers with B+1 and B+2 bits of the coding of the low band of a G.722 coder as well as the output values of the prior art improvement quantizer for B+2 bits.

As illustrated in this figure, the embedded quantizer with B+1=5 bits is obtained by “splitting” the levels of the quantizer with B=4 bits. The embedded quantizer with B+2=6 bits is obtained by “splitting” the levels of the quantizer with B+1=5 bits. The splitting of the reconstruction levels is in fact a consequence of the hierarchical coding constraint for the low band which is implemented in G.722 in the form of a tree-structured scalar quantization dictionary (with 4, 5 or 6 bits per sample).

In the prior art, the values enh_{2I}_{^{B+K−1}}₊ⱼ^{B+k} designating quantization reconstruction levels for an improvement stage k are defined by the difference between
the values designating the reconstruction levels of the quantization of an embedded quantizer with B+k bits (B designating the number of bits of the core coding) and
the values designating the quantization reconstruction levels of an embedded quantizer with B+k−1 bits, the reconstruction levels of the embedded quantizer with B+k bits being defined by splitting the reconstruction levels of the embedded quantizer with B+k−1 bits.
   With the invention the differential reconstruction levels enh_{2I}_{^{B+k−1}}₊ⱼ^{B+k} listed on the right and framed by dashes do not have to be computed or stored. According to the invention only the absolute reconstruction levels yᵢ^{B+k} of stage k are computed and stored.

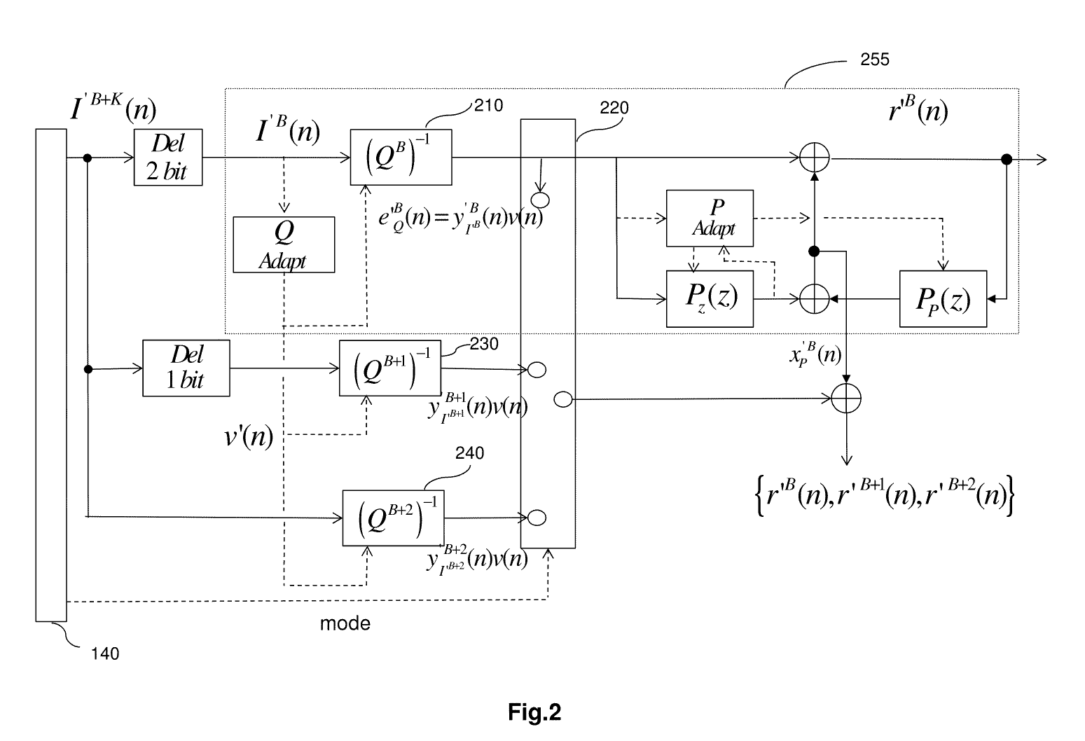

These absolute reconstruction levels yᵢ^{B+k} of stage k are used at the coder in the same manner as at the decoder, in the sense that the reconstructed signal can be obtained in the general case of the ADPCM coding on the basis of these absolute reconstruction levels yᵢ^{B+k} by multiplying by the scale factor v(n) and adding the prediction signal x_{P}^{B}(n) as already presented with reference to the description of FIG. 2 which represents the standard embedded-code ADPCM decoder. These levels already being defined and stored in the decoder, the coder does not therefore add any additional quantization table in the codec (coder+decoder).

The coding of the improvement stage according to the invention is very easily generalizable for the cases where the improvement stage adds several bits per sample. In this case the size of the dictionary Dₖ(n) used at the improvement stage, such as defined subsequently, is simply 2^{U} where U>1 is the number of bits per sample of the improvement stage.

The coder such as represented in FIG. 3 shows an embedded-code coder or hierarchical coder in which a core coding with B bits and at least one improvement stage of rank k is envisaged. The core coding and the improvement stages preceding the coding of improvement stage k such as represented at 306, deliver scalar quantization indices which are concatenated to form the indices of the preceding embedded coder I^{B+k-1}(n).

FIG. 3 illustrates in a simple manner a PCM/ADPCM coding module 302 representing the embedded coding preceding the improvement coding at 306.

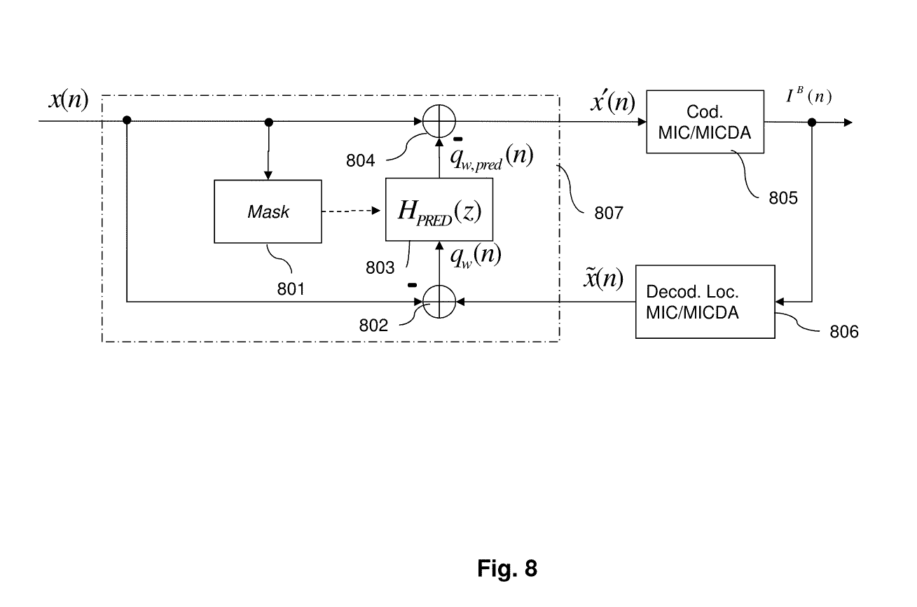

The core coding of the preceding embedded coding may optionally be performed using the masking filter determined at 301 to shape the “core” coding noise. An example of this type of core coding is described subsequently with reference to FIG. 8.

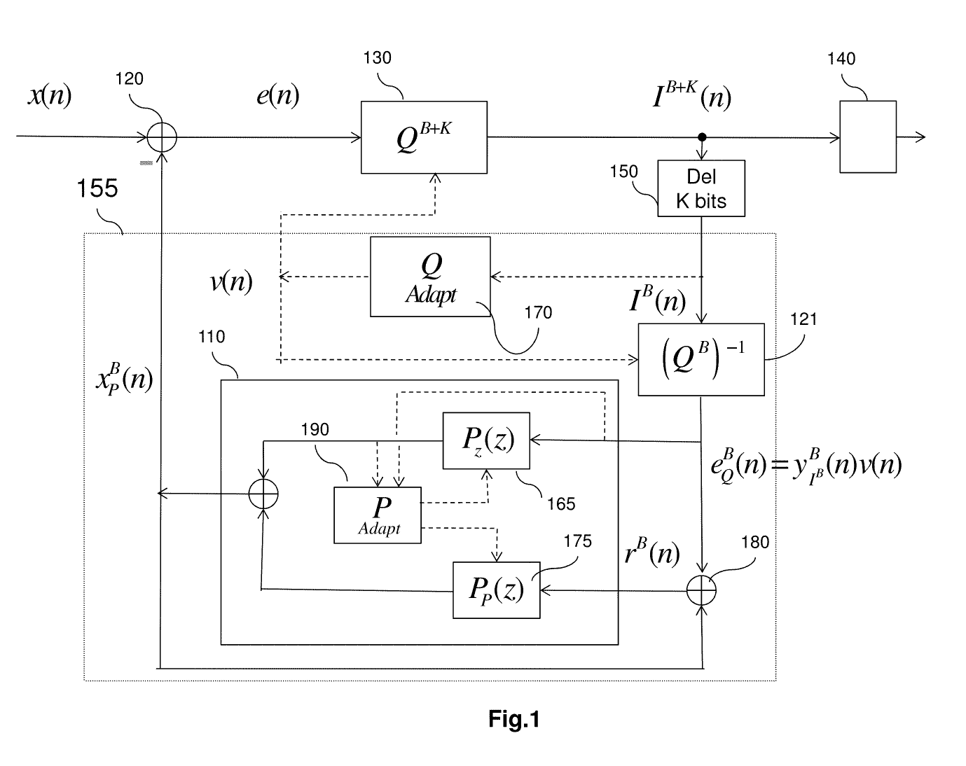

This module 302 thus delivers the indices I^{B+k-1}(n) of the embedded coder as well as the prediction signal x_{P}^{B}(n) and the scale factor v(n) in the case where one is indeed dealing with an ADPCM predictive coding similar to that described with reference to FIG. 1.

In the case of a PCM coding, the module 302 simply delivers the embedded quantization indices I^{B+k-1}(n). Moreover, it may be noted that PCM coding is a particular case of ADPCM coding by taking x_{P}^{B}(n)=0 and v(n)=1.

The knowledge of the embedded quantization indices I^{B+k-1}(n) and of the absolute reconstruction levels yᵢ^{B+k}, as well as if appropriate, the prediction signal x_{P}^{B}(n) and the scale factor v(n) make it possible to determine the quantization values Dₖ(n)={d₁^{B+k}(n), d₂^{B+k}(n)} for the current improvement stage k in the module for constructing the dictionary of the quantization values 303. This dictionary Dₖ(n) is used by the quantizer referred to here as the “improvement quantizer” for the improvement stage of rank k.

Thus, according to the favored embodiment, the quantization values of the dictionary are defined in the following manner, in the case of ADPCM coding:

d₁^{B+k}(n)=x_{P}^{B}(n)+y_{2I}_{^{B+k−1}}^{B+k}v(n) and d₂^{B+k}(n)=x_{P}^{B}(n)+y_{2I}_{^{B+k−1}}₊₁^{B+k}v(n),

where y_{2I}_{^{B+k−1}}₊ⱼ^{B+k}, with j=0 or 1, represent two possible quantization values of an embedded quantizer of B+k bits, which values are predefined and stored at the coder and at the decoder. It is possible to see the values yᵢ^{B+k} as arising from a “splitting” of the dictionary yᵢ^{B+k-1} of the preceding stage k−1.

It is noted that the two elements of the dictionary Dₖ(n) depend on I^{B+k-1}. In fact, this dictionary is a subset of the “absolute dictionary” defined as:

$${⋃}_{{I}^{B + k - 1}} {D}_{k} ( n ) = {⋃}_{{I}^{B + k - 1}} \{ {x}_{P}^{B} ( n ) + {y}_{2 {I}^{B + k - 1}}^{B + k} v ( n ) , {x}_{P}^{B} ( n ) + {y}_{2 {I}^{B + k - 1} + 1}^{B + k} v ( n ) \}$$

The “absolute dictionary” is a tree-structured dictionary. The index I^{B+k-1} conditions the various branches of the tree to be taken into account to determine the possible quantization values of stage k (Dₖ(n)).

The scale factor v (n) is determined by the core stage of the ADPCM coding as illustrated in FIG. 1, the improvement stage therefore uses this same scale factor to scale the code words of the quantization dictionary.

In one embodiment of the invention, the coder of FIG. 3 does not comprise the modules 301 and 310, that is to say that no provision is made for any coding noise shaping processing. Thus, it is the input signal x(n) itself which is quantized by the quantization module 306.

In a particular embodiment, the coder furthermore comprises a module 301 for computing a masking filter and determining the weighting filter W(z) or a predictive version W_{PRED}(z) described subsequently. The masking or weighting filter is determined here on the basis of the input signal x(n) but could very well be determined on the basis of a decoded signal, for example of the decoded signal of the preceding embedded coder \tilde{x}^{B+k-1}(n). The masking filter can be determined or adapted sample by sample or by block of samples.

Indeed, the coder according to the invention performs a shaping of the coding noise of the improvement stage by using a quantization in the domain weighted by the filter W(z), that is to say by minimizing the energy of the quantization noise filtered by W(z).

This weighting filter is used at 311 by the filtering module and more globally by the module 310 for perceptual weighting preprocessing of the input signal x(n). This preprocessing is applied directly to the input signal x(n) and not to an error signal as could have been the case in the prior art techniques.

This preprocessing module 310 delivers a modified signal x′(n) at the input of the improvement quantizer 307.

The quantization module 307 of improvement stage k delivers a quantization index Iₑₙₕ^{B+k}(n) which will be concatenated with the indices of the preceding embedded coding (I^{B+k-1}) to form the indices of the current embedded coding (I^{B+k}), by a module that is not represented here.

The quantization module 307 of improvement stage k chooses between the two values d₁^{B+k}(n) and d₂^{B+k}(n) of the adaptive dictionary Dₖ(n).

It receives as input the signal x′(n) and gives as output, by passing through the local decoding module 308, the quantized value \tilde{x}^{B+k}(n) (where \tilde{x}^{B+k}(n) is either equal to d₁^{B+k}(n) or to d₂^{B+k}(n)), by minimizing the quadratic error between x′(n) and \tilde{x}^{B+k}(n). The adaptive dictionary Dₖ(n) therefore contains directly the quantized output value of stage k.

The module 308 gives the quantized value of the input signal by inverse quantization of the index Iₑₙₕ^{B+k}(n). At the decoder the same value is obtained simply by directly using the inverse quantizer of stage k and the concatenated index: \tilde{x}^{B+k}(n)=x_{P}^{B}(n)+y_{I}_{^{B+k}}^{B+k}v(n).

This quantized signal is used to update the memories of the weighting filter W(z) of the improvement stage so as to obtain memories which corresponds to an input x(n)−\tilde{x}^{B+k} (n) Typically, the current value of the decoded signal \tilde{x}^{B+k}(n) is subtracted from the more recent memory (or memories in the case of the ARMA type filter).

Thus, the quantization of the signal x(n) is done in the weighted domain, which means that we minimize the quadratic error between x(n) and \tilde{x}^{B+k}(n) after filtering by the filter W(z). The quantization noise of the improvement stage is therefore shaped by a filter 1/W(z) to render this noise less audible. The energy of the weighted quantization noise is thus minimized.

The general embodiment of the block 310 given in FIG. 3 shows the general case where W(z) is an infinite impulse response (IIR) filter or a finite impulse response (FIR) filter. The signal x′(n) is obtained by filtering x(n) with W(z) and then when the quantized value \tilde{x}^{B+k}(n) is known, the memories of the filter W(z) are updated as if the filtering had been performed on the signal x(n)−\tilde{x}^{B+k}(n).

The dashed arrow represents the updating of the memories of the filter.

Thus, the steps implemented in the coder as illustrated in FIG. 3 are also represented. Indeed the following steps are found therein:
obtaining at 303 of possible quantization values ( ) for the current improvement stage k by determining absolute reconstruction levels of just the current stage k on the basis of the indices of the preceding embedded coder (I^{B+k-1});
quantization at 306 of the input signal of the hierarchical coder having undergone or not a perceptual weighting processing (x(n) or x′(n)), on the basis of said possible quantization values (dᵢ^{B+k}(n)) so as to form a quantization index for the stage k (Iₑₙₕ^{B+k}(n)) and a quantized signal (\tilde{x}^{B+k}(n)) corresponding to one of the possible quantization values.

In the case represented in FIG. 3, the input signal has undergone a perceptual weighting processing at 310 using a weighting filter predetermined at 301 to give a modified input signal x′(n), before the quantization step at 306.

FIG. 3 also represents the adaptation step at 311 for adapting the memories of the weighting filter on the basis of the quantized signal (\tilde{x}^{B+k}(n)) of the current improvement coding stage.

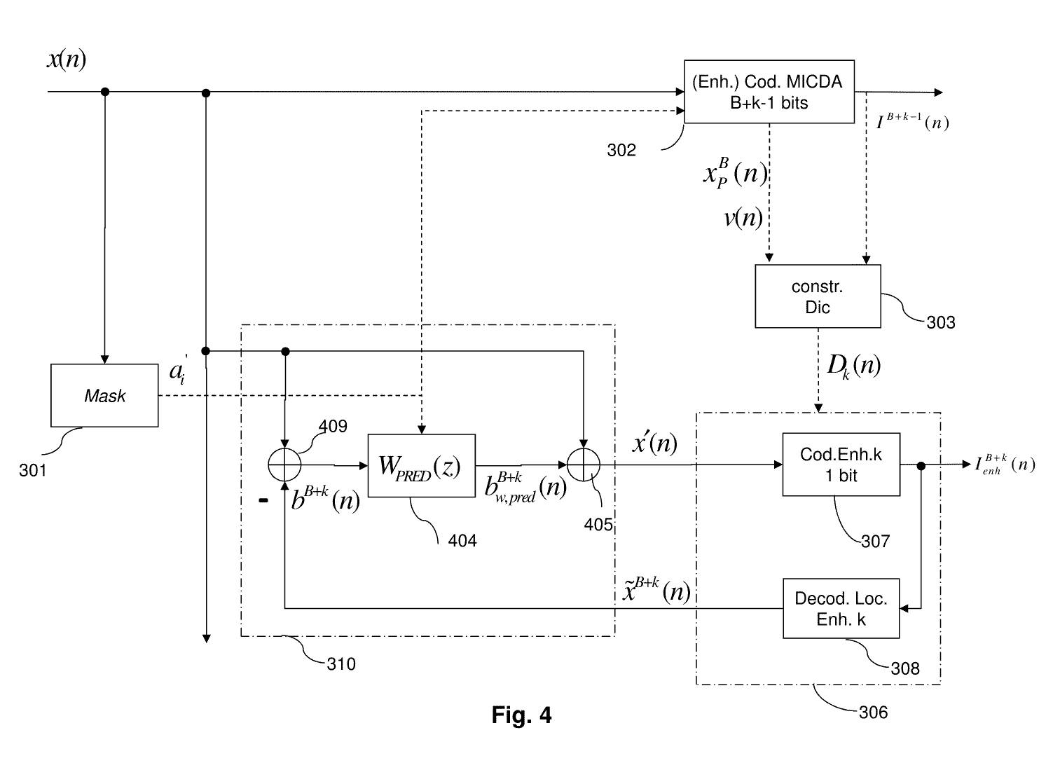

FIGS. 4, 5 and 6 now describe particular embodiments of the preprocessing block 310.

The blocks 301, 302, 303, 306, 307 and 308 then remain identical to those described with reference to FIG. 3.

FIG. 4 represents a first embodiment of the preprocessing block 310 with a filter W(z)=A′(z) with finite impulse response (FIR).

In this embodiment, the memory of the filter contains solely the past input samples of the signal x(n)−\tilde{x}^{B+k}(n), denoted:

b^{B+k}(n′), n′=n−1, . . . , n−N_{D}.

N_{D} being the order of the perceptual filter W(z).

At 302, the input signal x(n) is coded by the PCM/ADPCM coding module 302, with or without shaping of the coding noise of the embedded coder B+k−1.

At 303, an adaptive dictionary Dₖ is constructed as a function of the prediction values x_{P}^{B}(n), of the scale factor v(n) of the core stage in the case of a coding of ADPCM adaptive type and of the coding indices I^{B+k-1}(n) as explained with reference to FIG. 3. The adaptive dictionary Dₖ comprises in the particular embodiment where a single improvement bit is envisaged in improvement stage k, the following two terms: d₁^{B+k}(n)=x_{P}^{B}(n)+y_{2I}_{^{B+k−1}}^{B+k}v(n) and d₂^{B+k}(n)=x_{P}^{B}(n)+y_{2I}_{^{B+k−1}}₊₁^{B+k}v(n).

In this embodiment are found the steps of computing at 301 the masking filter and determining the weighting filter W(z), as well as its predictive version W_{PRED} (z) based on predictions, that is to say computations using past samples alone.

Let us recall here the definition of a predictive filter:

Let us take as an example the case of filtering a signal x(n) with the non-recursive filter with all-zero transfer function (also termed FIR for Finite Impulse Response) A(z) of order 4,

$$A ( z ) = 1 + {\sum }_{i = 1}^{4} {a}_{i} {z}^{- i} ,$$

giving as result a signal y(n). In the domain of the z-transform, the equation

Y(z)=A(z)X(z)

corresponds to the difference equation

y(n)=α₀x(n)+α₁x(n−1)+α₂x(n−2)+α₃x(n−3)+α₄x(n−4)

This expression for y(n) can be divided into two parts:
the first depends only on the present input x(n): α₀x(n). Usually and in the cases of interest to us in this document, a₀=1
the second which depends only on the past input x(n−i), i>0: α₁x(n−1)+α₂x(n−2)+α₃x(n−3)+α₄x(n−4) which will therefore be considered to be the predictive part of the filtering by analogy with the linear prediction where it represents the prediction of x(n) on the basis of the previous samples.

This second part corresponds for sampling instant n to the “zero input response” (ZIR) or else “ringing” which is in fact a generalized prediction. The z-transform of this component is:

Y_{PRED}(z)=(A(z)−1)X(z)=H_{A,PRED}(z)X(z) with H_{A,PRED}(z)=A(z)−1

In a similar manner, for the filtering of a signal x(n) by an all-pole recursive filter

$$\frac{1}{B ( z )}$$

of order 4 with

$$B ( z ) = 1 + {\sum }_{i = 1}^{4} {b}_{i} {z}^{- i} ,$$

resulting in a signal y(n), the transfer function gives:

$$Y ( z ) = \frac{1}{B ( z )} X ( z )$$

with difference equation:

y(n)=x(n)−b₁y(n−1)−b₂y(n−2)−b₃y(n−3)−b₄y(n−4)

The innovation part is x(n), the predictive part is −b₁y(n−1)−b₂y(n−2)−b₃y(n−3)−b₄y(n−4),

with z-transform Y_{PRED}(z)=−(B(z)−1)Y(z)=(1−B(z))Y(z).

The same holds for the case where the filter contains at one and the same time zeros and poles (ARMA (AutoRegressive Moving Average) filter):

$$Y ( z ) = \frac{A ( z )}{B ( z )} X ( z )$$

with difference equation (in this example A(z) and B(z) are of order 4):

$$y ( n ) = x ( n ) + {\sum }_{i = 1}^{4} {a}_{i} x ( n - i ) - {\sum }_{i = 1}^{4} {b}_{i} y ( n - i )$$

The innovation part is x(n), the predictive part is

$${\sum }_{i = 1}^{4} {a}_{i} x ( n - i ) - {\sum }_{i = 1}^{4} {b}_{i} y ( n - i ) ,$$

with z-transform Y_{PRED}(z)=(A(z)−1)X(z)−(B(z)−1)Y(z), or

$${Y}_{PRED} ( z ) = \frac{A ( z ) - 1}{B ( z )} X ( z ) = {H}_{AB , PRED} ( z ) X ( z ) with$$

$${H}_{AB , PRED} ( z ) = \frac{A ( z ) - 1}{B ( z )} .$$

Hereinafter, generally H_{PRED}(z) denotes a filter whose coefficient for its current input x(n) is zero.

The all-pole

$$\frac{1}{B ( z )} or ARMA \frac{A ( z )}{B ( z )}$$

recursive filters are the so-called IIR (Infinite Impulse Response) filters.

In the present case, in FIG. 4, by using the cutting of a filtering into innovation and predictive parts, the term whose energy has to be minimized is then:

(x(n)+x_{PRED}(n))−(\tilde{x}^{B+k}(n)+\tilde{x}_{PRED}^{B+k}(n))

The signal to be quantized by the improvement quantizer of stage k is therefore

x′(n)=x(n)+x_{PRED}(n)−\tilde{x}_{PRED}^{B+k}(n)

where X_{PRED}(n) and \tilde{x}_{PRED}^{B+k}(n) x are obtained by filtering x(n) and \tilde{x}^{B+k}(n) with the prediction filter W_{PRED}(z). These two filterings can be combined into one, the input of the common filter W_{PRED} (z) will then be b^{B+k}(n)=x(n)−\tilde{x}^{B+k}(n) (for example by updating the memory of the filter). As output of the filtering is then obtained:

b_{w,PRED}^{B+k}(n)=x_{PRED}(n)−\tilde{x}_{PRED}^{B+k}(n).

The preprocessing module 310 implements the steps of computing a prediction b_{w,PRED}^{B+k}(n) by filtering with W_{PRED}(z) at 404, of the past samples of the signal x(n)−\tilde{x}^{B+k}(n)=b^{B+k}(n) n=−1, −2, . . . , −N_{D} obtained at 409.

This prediction b_{w,PRED}^{B+k}(n) is added to the input signal x(n) at 405 to obtain the modified input signal x′(n) of the quantizer of improvement stage k.

The quantization of x′(n) is performed at 306 by the quantization module of improvement stage k, to give the quantization index Iₑₙₕ^{B+k}(n) of improvement stage k and the decoded signal \tilde{x}^{B+k}(n) of stage k. The module 307 gives the index of the code word Iₑₙₕ^{B+k}(n) (1 bit in the exemplary illustration) of the adaptive dictionary Dₖ which minimizes the quadratic error between x′(n) and the quantization values d₁^{B+k}(n) and d₂^{B+k}(n). This index has to be concatenated with the index of the preceding embedded coder I^{B+k-1} to obtain at the decoder the index of the code word of stage k I^{B+k}. The module 308 gives the quantized value of the input signal by inverse quantization of the index Iₑₙₕ^{B+k}(n), \tilde{x}^{B+k}(n)=d_{I}_{ₑₙₕ₁}_{^{B+k}}^{B+k}(n).

At the decoder the same value is obtained simply by directly using the inverse quantization of stage k and the concatenated index to obtain: \tilde{x}^{B+k}(n)=x_{P}^{B}(n)+y_{I}_{^{B+k}}^{B+k}v(n).

At 409, a step of computing the coding noise b^{B+k}(n) of the coder including stage k is performed by subtracting the input signal x(n) from the synthesized signal of stage k \tilde{x}^{B+k}(n) for the present samples (n=0).

The operations of preprocessing the block 310 thus make it possible to shape the improvement coding noise of stage k by performing a perceptual weighting of the input signal x(n). It is the input signal itself which is perceptually weighted and not an error signal as is the case in the prior art schemes.

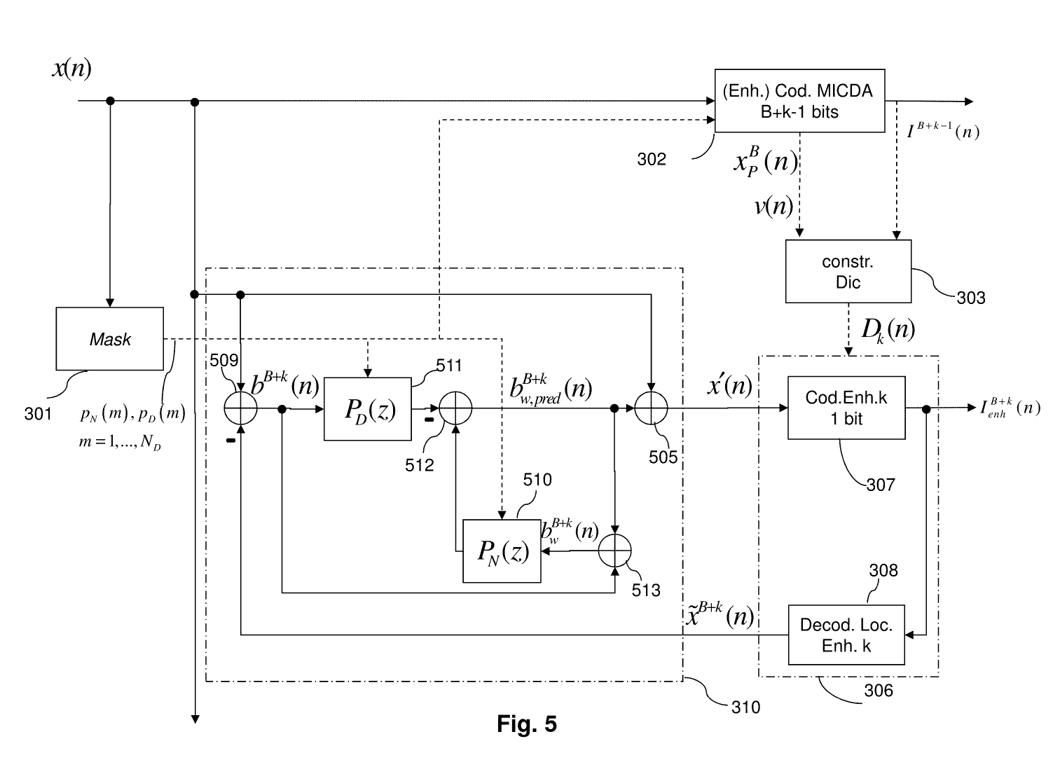

FIG. 5 illustrates another exemplary embodiment of the preprocessing module using in this embodiment a filtering of ARMA (AutoRegressive Moving Average) type with transfer function:

$$W ( z ) = \frac{1 - {P}_{D} ( z )}{1 - {P}_{N} ( z )}$$

The operations according to FIG. 5 are strung together as follows:
Computation at 301 of the masking filter and determination of the weighting filter

$$W ( z ) = \frac{1 - {P}_{D} ( z )}{1 - {P}_{N} ( z )} ;$$

Coding at 302 of the input signal x(n) by an embedded coder of PCM/ADPCM type of B+k−1 bits, optionally with shaping of the coding noise using the masking filter determined at 301 to shape the coding noise;
Determination at 303 of the adaptive dictionary Dₖ as a function of the prediction values x_{P}^{B}(n) and of scale factor v(n) (in the case of an ADPCM coding) of the core stage, and of the quantization indices I^{B+k-1}(n) (d₁^{B+k}(n)=x_{P}^{B}(n)+y_{2I}_{^{B+k−1}}^{B+k}v(n) and d₂^{B+k}(n)=x_{P}^{B}(n)+y_{2I}_{^{B+k−1}}₊₁^{B+k}v(n)).

These steps are equivalent to that which are described with reference to FIG. 3.

The preprocessing module 310 comprises a step of computing at 512 a prediction signal b_{w,pred}^{B+k}(n) of the filtered quantization noise b_{w}^{B+k}(n), by adding the prediction computed at 510 on the basis of the samples of the filtered reconstructed noise

$${\sum }_{m = 1}^{{N}_{D}} {p}_{N} ( m ) {b}_{w}^{B + k} ( n - m )$$

and by deducting the prediction computed at 511 on the basis of the reconstructed noise

$${\sum }_{m = 1}^{{N}_{D}} {p}_{D} ( m ) {b}^{B + k} ( n - m ) .$$

At 505, a step of adding the prediction signal b_{w,pred}^{B+k}(n) to the signal x(n) is performed to give the modified signal x′(n).

The step of quantizing the modified signal x′(n) is performed by the quantization module 306, in the same manner as that explained with reference to FIGS. 3 and 4.

Thus, the quantization of the block 306 gives as output the index Iₑₙₕ^{B+k}(n) and the decoded signal at stage k \tilde{x}^{B+k}(n).

At 509, a step of subtracting the reconstructed signal \tilde{x}^{B+k}(n) from the signal x(n) is performed, to give the reconstructed noise b^{B+k}(n).

At 513, a step of adding the prediction signal b_{w,pred}^{B+k}(n) to the signal b^{B+k}(n) is performed to give the filtered reconstructed noise b_{w}^{B+k}(n).

All the steps performed at 505, 509, 510, 511, 512 and 513 by the modules of the preprocessing block 310, make it possible to shape the coding noise for improvement coding stage k. This shaping of the noise is then performed by two prediction filters thus constituting an ARMA filter which affords a better accuracy of noise shaping.

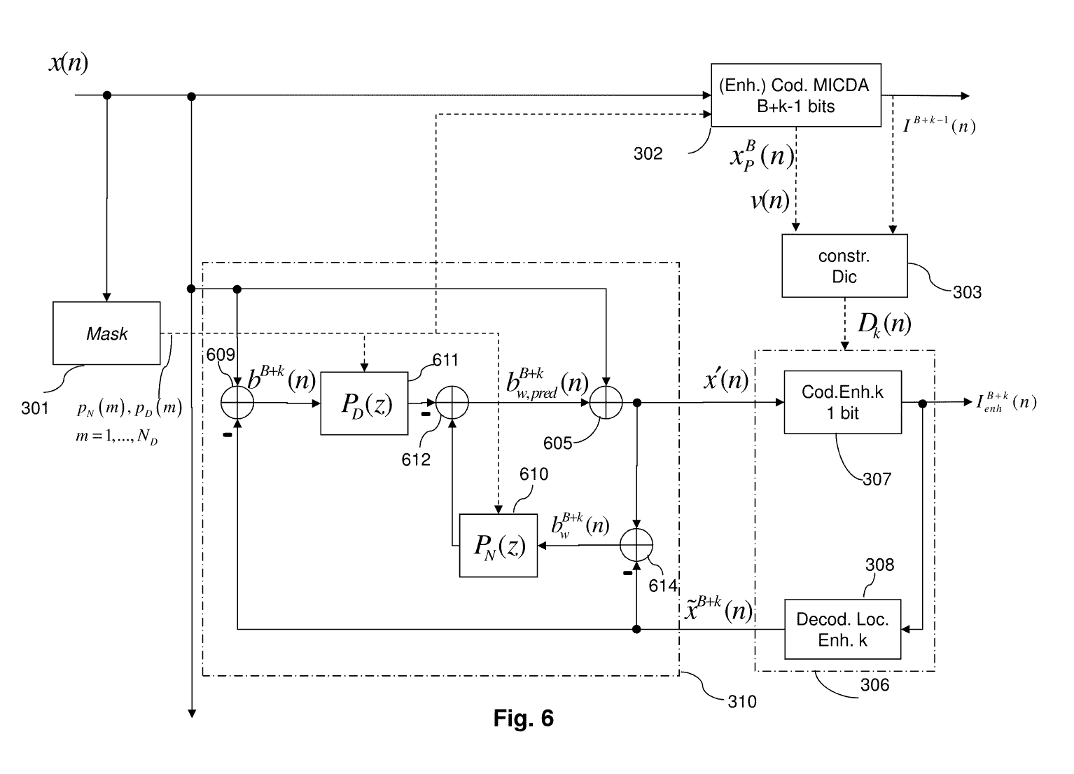

FIG. 6 illustrates yet another embodiment of the preprocessing block 310 where here the difference resides in the way in which the filtered reconstructed signal b_{w}^{B+k}(n) is computed. The filtered reconstructed noise b_{w}^{B+k}(n) is obtained here by subtracting the reconstructed signal \tilde{x}^{B+k}(n) from the signal x′(n) at 614.

In FIGS. 5 and 6 described hereinabove, it is possible to also speak of updating the memories of the weighting filters on the basis of the filtered reconstructed noise signal b_{w}^{B+k}(n) for the past samples.

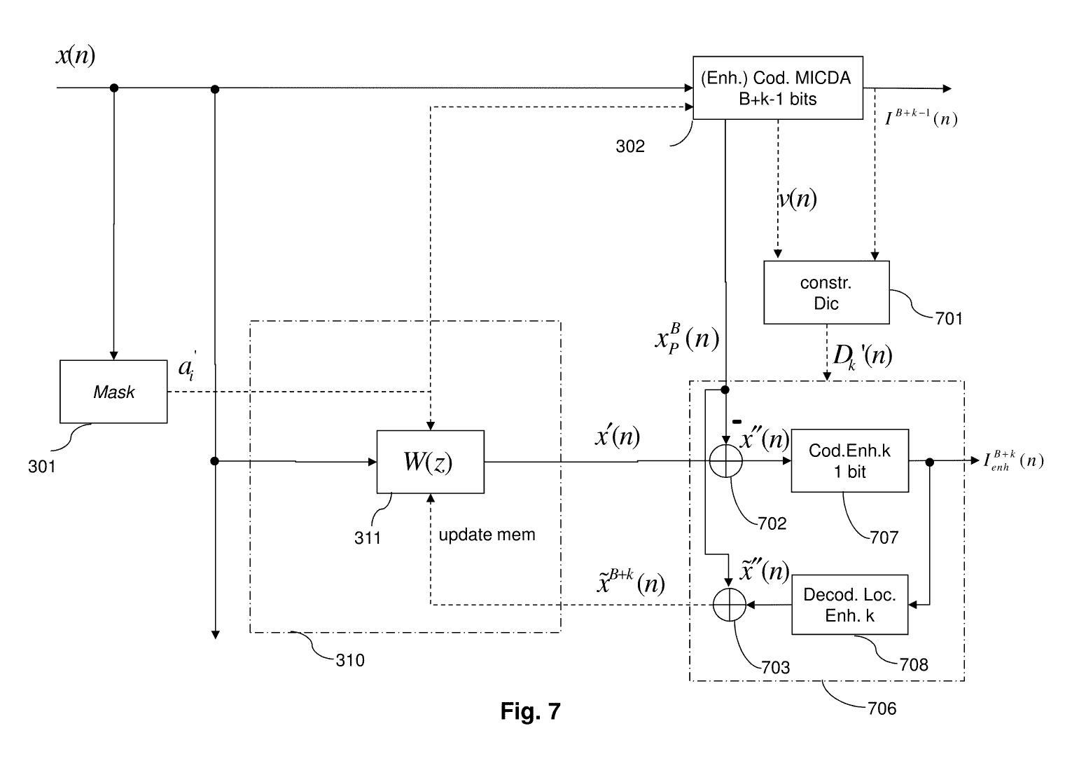

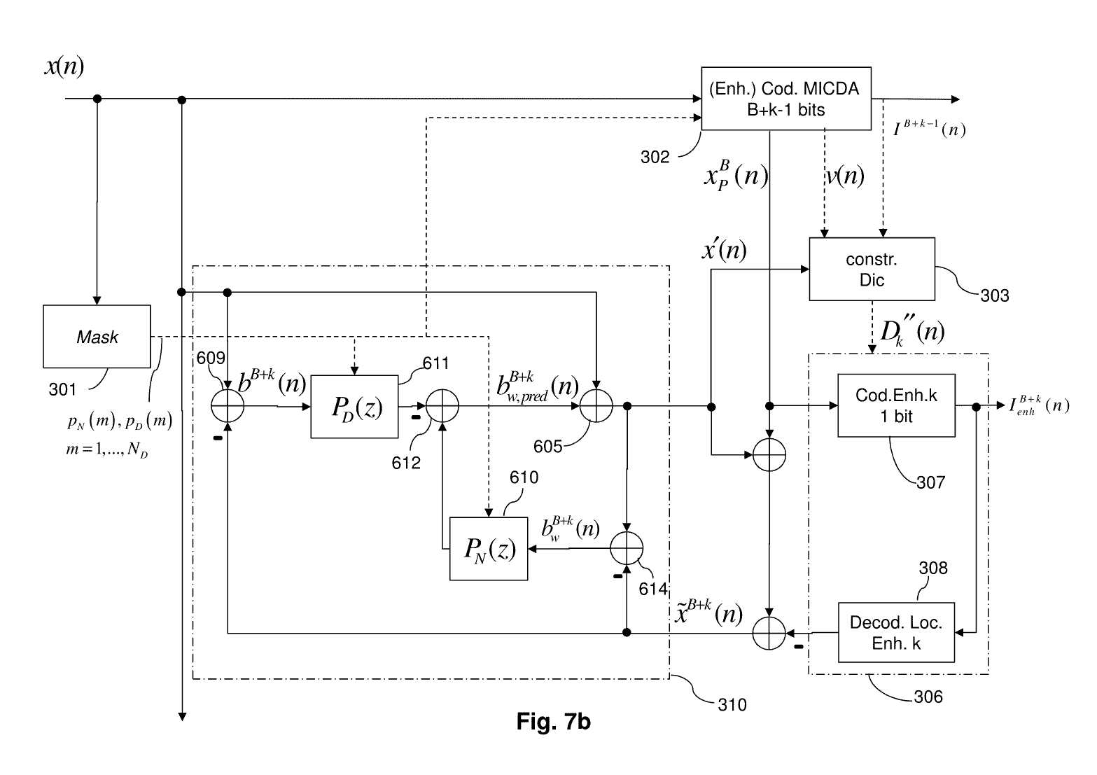

FIG. 7 illustrates an alternative embodiment for the step 306 of quantizing the signal x′(n) by processing differently the predicted signal x_{P}^{B}(n) originating from the core coding. This embodiment is presented with the exemplary preprocessing block 310 presented in FIG. 3, but may obviously be integrated with preprocessing blocks described in FIGS. 4, 5 and 6. The operations according to FIG. 7 are strung together as follows:
Computation at 301 of the masking filter and determination of the weighting filter W(z) or of its predictive version W_{PRED}(z);
Coding at 302 of the input signal x(n), by an embedded coder of PCM/ADPCM type of B+k−1 bits, optionally with shaping of the coding noise using the masking filter determined at 301 to shape the coding noise;
Determination at 701 of the adaptive dictionary Dₖ′ as a function of the scale factor v (n) of the core stage (in the case of an ADPCM coding) and of the quantization indices I^{B+k-1}(n) of the embedded coding preceding stage k (d₁^{B+k′}(n)=y_{2I}_{^{B+k−1}}^{B+k}v(n) and d₂^{B+k′}(n)=y_{2I}_{^{B+5−1}}₊₁^{B+k}v(n));
Filtering of the signal x(n) with W (z) at 311 to obtain the modified input signal x′(n) of the improvement quantizer, with values corresponding to an input signal x(n)−\tilde{x}_{B+k}(n) as memories of the filter W(z);
Quantization of x′(n) at 706 to give the index Iₑₙₕ^{B+k}(n) and the decoded signal at stage k \tilde{x}^{B+k}(n).

In this embodiment, the predicted signal x_{P}^{B}(n) of the core stage is subtracted from the signal x′(n) (module 702) to obtain the modified signal x″(n)=x′(n) x_{P}^{B}(n).

The module 707 gives the index of the code word Iₑₙₕ^{B+k}(n) (1 bit in the exemplary illustration) of the adaptive dictionary Dₖ′ which minimizes the quadratic error between x″(n) and the code words d₁^{B+k′}(n) and d₂^{B+k′}(n). This index has to be concatenated with the index of the preceding embedded coding I^{B+k-1} to obtain at the decoder the index of the current embedded coding I^{B+k} comprising stage k.

The module 708 gives the quantized value of the signal x″(n) by inverse quantization of the index Iₑₙₕ^{B+k}(n), \tilde{x}″(n)=d_{I}_{ₑₙₕ₁}_{^{B+k}}^{B+k}′(n). The module 703 computes the quantized signal of stage k by adding together the predicted signal and the output signal from the quantizer \tilde{x}^{B+k}(n)=x_{P}^{B}(n)+\tilde{x}″(n).

Finally, a step of updating the memories of the filter W (z) is performed at 311, to obtain memories which correspond to an input x(n)−\tilde{x}^{B+k}(n). Typically, the current value of the decoded signal \tilde{x}^{B+k}(n) is subtracted from the more recent memory (or memories in the case of the ARMA type filter).

The solution in FIG. 7 is equivalent in terms of quality and storage to that of FIG. 3, but requires fewer computations in the case where the improvement stage uses more than one bit. Indeed, instead of adding the predicted value x_{P}^{B}(n) to all the code words (>2) we do just one subtraction before the quantization and just one addition to retrieve the quantized value \tilde{x}^{B+k}(n). The complexity is therefore reduced.

Another alternative embodiment is illustrated in FIG. 7b. Here, the adaptive dictionary Dₖ″ is constructed by subtracting the reconstruction levels, weighted if appropriate by the scale factor v(n), of stage k from the modified input signal (d₁^{B+k″}(n)=x′(n)−y_{2I}_{^{B+k−1}}^{B+k}v(n) and d₂^{B+k″}(n)=x′(n)−y_{2I}_{^{B+k−1}}₊₁^{B+k}v(n)). In this typical case, it is the prediction signal x_{P}^{B}(n) that is quantized by minimizing the quadratic error. Next the decoded signal \tilde{x}^{B+k}(n) for updating the memories is obtained in the following manner: \tilde{x}^{B+k}(n)=x′(n)+x_{P}^{B}(n)−d_{I}_{ₑₙₕ₁}_{^{B+k}}^{B+k}″(n).

FIG. 8 details a possible implementation of a shaping of the noise at the core coding. The module 801 computes the coefficients of the noise shaping filter

$${P}_{1} ( z ) = \frac{1}{A ( z / γ )} or {P}_{2} ( z ) = \frac{A ( z / {γ}_{1} )}{A ( z / {γ}_{2} )} .$$

The module 802 computes the coding error q_{w}(n)=\tilde{x}(n)−x(n) of the previous sampling instants, n−1, n−2, . . . . This error is filtered by a predictor filter H_{PRED}(z) to obtain the prediction signal q_{w,pred}(n). The filter H(z) corresponding to H_{PRED}(z) can be equal for example either to

$$H ( z ) = \frac{1}{{P}_{1} ( z )} = A ( z / γ ) , or to$$

$$H ( z ) = \frac{1}{{P}_{2} ( z )} = \frac{A ( z / {γ}_{2} )}{A ( z / {γ}_{1} )} .$$

At the instant n, this predicted value will be subtracted from the signal to be coded to obtain the modified signal to be coded x′(n)=x(n)−q_{w,pred}(n).

The difference between the input and the output of the PCM/ADPCM coder-PCM/ADPCM decoder chain, q(n)=\tilde{x}(n)−x′(n), can be considered in the short term to be white noise when these coders use a quantizer with a large number of levels and assuming the input signal to be stationary.

Let us take the example where

$$H ( z ) = \frac{1}{{P}_{1} ( z )} = A ( z / γ ) .$$

The input signal of the PCM/ADPCM standard coding chain is modified by the subtraction of the contribution (H(z)−1)(\tilde{X}(z)−X(z)). It follows from this that the coding noise of the complete chain q_{G}(n)=\tilde{x}(n)−x(n) will be shaped by the filter

$$\frac{1}{H ( z )} : {Q}_{G} ( z ) = \frac{Q ( z )}{H ( z )} = \frac{1}{A ( z / γ )} Q ( z ) ,$$

here is the proof in terms of equations:

$$\begin{matrix}\tilde{X} ( z ) = {X}^{′} ( z ) + Q ( z ) \\ = X ( z ) - ( H ( z ) - 1 ) ( \tilde{X} ( z ) - X ( z ) ) + Q ( z ) = \\ = \tilde{X} ( z ) - H ( z ) \tilde{X} ( z ) + H ( z ) X ( z ) + Q ( z )\end{matrix}$$

$$Hence$$

$$H ( z ) \tilde{X} ( z ) = H ( z ) X ( z ) + Q ( z ) and therefore$$

$$\tilde{X} ( z ) = X ( z ) + \frac{Q ( z )}{H ( z )}$$

In fact, the filter H_{PRED}(z)=H(z)−1 has a zero coefficient in z⁰ (for the instant n), it is therefore a predictor acting on q_{w}(n)=\tilde{x}(n)−x(n) which, for its part, is known only at the end of the PCM/ADPCM processing when the decoded value \tilde{x}(n) is known.

The sequence of operations of FIG. 8 is as follows:
Computation at 801 of the masking filter and determination of the filter H(z). Note that the filter H(z) can also be determined on the basis of the decoded signal \tilde{x}(n);
Computation at 803 of the prediction q_{w,pred}(n), ([H(z)−1]Q_{w}(z)), on the basis of the values q_{w}(n)=\tilde{x}(n)−x(n) of the previous sampling instants, n−1, n−2, . . . ;
Subtraction at 804 of the prediction q_{w,pred}(n) from x(n) to obtain the modified signal x′(n);
Coding/Decoding at 805-806 of the modified signal x′(n) by a standard PCM/ADPCM coder/decoder. The local decoder can be a standard local decoder of the PCM/ADPCM type of standards G.711, G.721, G.726, G.722 or else G.727.
Computation at 802 of the filtered coding noise q_{w}(n) by subtraction of the input signal x(n) from the output signal \tilde{x}(n).

The surrounded part 807 can be viewed and implemented as a noise shaping preprocessing which modifies the input of the standard coder/decoder chain.

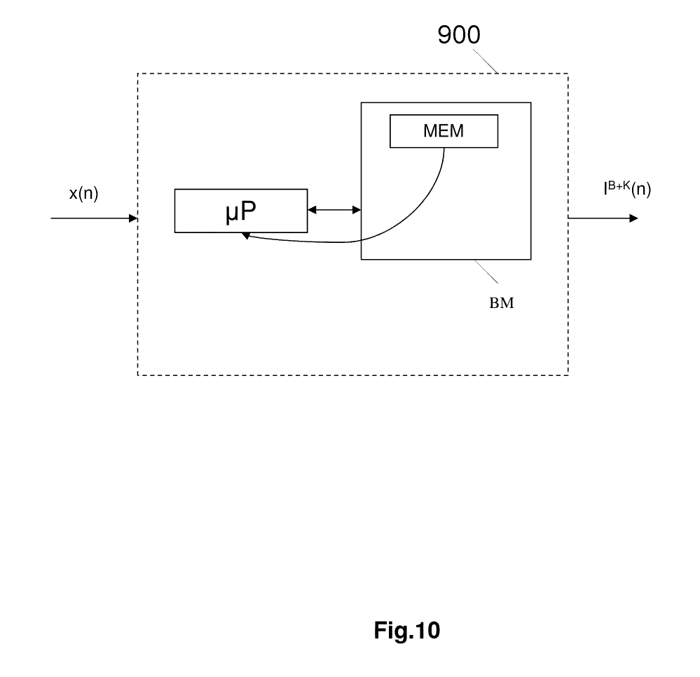

An exemplary embodiment of a coder according to the invention is now described with reference to FIG. 10.

In terms of hardware, a coder 900 such as described according to the various embodiments hereinabove, within the meaning of the invention, typically comprises, a processor μP cooperating with a memory block BM including a storage and/or work memory, as well as an aforementioned buffer memory MEM as means for storing for example a dictionary of quantization reconstruction levels or any other data necessary for the implementation of the coding method such as described with reference to FIGS. 3, 4, 5, 6 and 7. This coder receives as input successive frames of the digital signal x(n) and delivers concatenated quantization indices I^{B+K}.

The memory block BM can comprise a computer program comprising the code instructions for the implementation of the steps of the method according to the invention when these instructions are executed by a processor μP of the coder and especially the steps of obtaining possible quantization values for the current improvement stage k by determining absolute reconstruction levels of just the current stage k on the basis of the indices of the preceding embedded coder, of quantizing the input signal of the hierarchical coder having undergone or not a perceptual weighting processing (x(n) or x′(n)), on the basis of said possible quantization values so as to form a quantization index for stage k and a quantized signal corresponding to one of the possible quantization values.

In a more general manner, a storage means, readable by a computer or a processor, possibly integrated into the coder, optionally removable, stores a computer program implementing a coding method according to the invention.

FIGS. 3 to 7 can for example illustrate the algorithm of such a computer program.

1. A method for coding a digital audio input signal (x(n)) in a hierarchical coder comprising a core coding stage with B bits and at least one current improvement coding stage k, core coding and coding of the improvement stages preceding a current stage k delivering quantization indices which are concatenated to form indices of a preceding embedded coder (I^{B+k-1}) the method comprising the following steps:
obtaining possible quantization values (dᵢ^{B+k}(n)) for the current improvement stage k on the basis of absolute reconstruction levels (yᵢ^{B+k}) of just the current stage k and of the indices of the preceding embedded coder (I^{B+k-1});
quantization of the input signal of the hierarchical coder having undergone or not a perceptual weighting processing (x(n) or x′(n)), on the basis of said possible quantization values (dᵢ^{B+k}(n)) so as to form a quantization index for the stage k (Iₑₙₕ^{B+k}(n)) and a quantized signal (\tilde{x}^{B+k}(n)) corresponding to one of the possible quantization values.

2. The method as claimed in claim 1, wherein the input signal has undergone a perceptual weighting processing using a predetermined weighting filter to give a modified input signal x′(n), before the quantization step and the method furthermore comprises a step of adapting memories of the weighting filter on the basis of the quantized signal (\tilde{x}^{B+k}(n)) of the current improvement coding stage.

3. The method as claimed in claim 1, wherein the possible quantization values for improvement stage k furthermore contain a scale factor and a prediction value originating from the core coding of an adaptive type.

4. The method as claimed in claim 2, wherein the modified input signal (x″(n)) to be quantized at improvement stage k is the perceptually weighted input signal from which is subtracted a prediction value originating from the core coding of adaptive type.

5. The method as claimed in claim 1, wherein the perceptual weighting processing is performed by prediction filters forming a filter of an ARMA type.

6. A hierarchical coder of a digital audio input signal (x(n)), comprising a core coding stage with B bits and at least one current improvement coding stage k, core coding and coding of the improvement stages preceding current stage k delivering quantization indices which are concatenated to form indices of a preceding embedded coder (I^{B+k-1}), the coder comprising:
a module configured to obtain possible quantization values (dᵢ^{B+k}(n))) for the current improvement stage k by determining absolute reconstruction levels of just the current stage k on the basis of the indices of the preceding embedded coder (I^{B+k-1});
a module configured to quantize the input signal of the hierarchical coder having undergone or not a perceptual weighting processing (x(n) or x′(n)), on the basis of said possible quantization values (dᵢ^{B+k}(n)) so as to form a quantization index for the stage k (Iₑₙₕ^{B+k}(n)) and a quantized signal (\tilde{x}(n)) corresponding to one of the possible quantization values.

7. The hierarchical coder as claimed in claim 6, wherein the coder furthermore comprises a preprocessing module configured to perform a perceptual weighting using a predetermined weighting filter to give a modified input signal (x′(n)) at the input of the quantization module and a module configured to adapt memories of the weighting filter on the basis of the quantized signal (\tilde{x}^{B+k}(n)) of the current improvement coding stage.

8. A computer-readable hardware storage medium comprising a computer program stored thereon and comprising code instructions for implementing a method of coding a digital audio input signal (x(n)) in a hierarchical coder comprising a core coding stage with B bits and at least one current improvement coding stage k, when these instructions are executed by a processor, wherein core coding and coding of improvement stages precede a current stage k delivering quantization indices which are concatenated to form indices of a preceding embedded coder (I^{B+k-1}), the method comprising the following steps:
obtaining possible quantization values (dᵢ^{B+k}(n)) with the processor for the current improvement stage k on the basis of absolute reconstruction levels (yᵢ^{B+k}) of just the current stage k and of the indices of the preceding embedded coder (I^{B+k-1});
quantization, with the processor, of the input signal of the hierarchical coder having undergone or not a perceptual weighting processing (x(n) or x′(n)), on the basis of said possible quantization values (dᵢ^{B+k}(n)) so as to form a quantization index for the stage k (Iₑₙₕ^{B+k}(n)) and a quantized signal (\tilde{x}^{B+k}(n)) corresponding to one of the possible quantization values.
